(19) United States
(12) Patent Application Publication
(10) Pub. No.: US 2006/0059497 A1
(43) Pub. Date: Mar. 16, 2006

(54) Object-oriented system for networking onboard aeronautical equipment items

(76) Inventors: Stephane Leriche, Tournefeuille (FR); Elias Bitar, Toulouse (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/519,100

(22) PCT Filed: Jun. 27, 2003
(86) PCT No.: PCT/FR03/01999

§ 371 Date: Dec. 27, 2004

(30) Foreign Application Priority Data
Jul. 5, 2002 (FR) 02/08469

(51) Int. Cl. G06F 9/46

(52) U.S. Cl. 719/313

(57) ABSTRACT

This system for networking aeronautical equipment on board an aircraft comprises, for each equipment item, an object-oriented interface with object aspect means, enabling it to know the onboard equipment to which it is assigned, as an object, in the object-oriented programming sense, capable of communicating with other objects in the object-oriented programming sense according to an object-oriented client/server model and with observer means recording events resulting from the operation of the onboard equipment.

The present invention relates to data interchanges between equipment on board an aircraft.

Aircraft are increasingly being equipped with electronic equipment, some for sensing the positions of moving items such as flaps, rudders, air brakes, landing gear, etc., others displaying flight parameters, others aiding piloting or navigation such as the automatic pilots or flight computers, others used for information interchanges with the ground or with other aircraft, yet others used to monitor the immediate vicinity of the aircraft, and so on. All of this equipment on board an aircraft is normally known collectively by the generic term of avionics system.

Avionics systems vary widely from one aircraft to another, and, for safety reasons, are subject to certification procedures which make it very costly to develop them in the first place and modify them subsequently for upgrades throughout the period of operation of an aircraft, which can extend over several decades.

To avoid losing certification, any change to the avionics system of an aircraft involves repeating the certification procedures both with respect to the modified or added equipment and with respect to the way these modifications or equipment additions affect the unmodified, existing equipment of the avionics system.

For example, adding an air traffic collision avoidance system entails providing a connection with the flight computer so that the collision avoidance system can be supplied with the speed vector and position coordinates of the aircraft. If such a connection is not allowed for in the design of the flight computer, its creation will entail modifications to the flight computer, so necessitating a more or less complete repeat of the relevant certification procedures.

Modifying and recertifying existing equipment of the avionics system of an aircraft so that new equipment can be added is an operation that is often complicated by the fact that the manufacturer of the equipment to be added is often not the same as those of the existing equipment to be modified, which entails setting up collaborations between different manufacturers with their attendant negotiations, which considerably adds to the cost and time needed to update an avionics system.

The object of the present invention is to facilitate the introduction of new equipment into an avionics system, when this new equipment needs to exchange information with equipment that is already in place, but was not initially designed to cooperate with the new equipment, and this by using the object-oriented programming approach with respect to the different equipment of the avionics system.

Its object is to produce a system for networking aeronautical equipment on board an aircraft comprising, for each item of equipment, an object-oriented interface with object aspect means, enabling it to recognize the onboard equipment to which it is assigned, as an object, in the object-oriented programming sense, capable of communicating with other objects in the object-oriented programming sense according to an object-oriented client/server model and with observer means recording events resulting from operation of the onboard equipment.

The approach whereby the onboard equipment of an aircraft is perceived as so many objects, in the object-oriented programming sense, capable of communicating according to an object-oriented client/server model, means that they can be made to intercommunicate by considering them as black boxes, in other words, by disregarding the way in which they fulfil the tasks or services to which they are assigned. This minimizes the interventions on the existing equipment and therefore the operations needed to recertify a modified avionics system.

The design of the object aspect of an object-oriented interface enabling aeronautical equipment on board an aircraft to be perceived as an object, in the object-oriented programming sense, capable of communicating according to an object-oriented client/server model and of its observer means recording events resulting from the operation of the equipment, is made possible by the fact that the different states that aeronautical equipment can assume, the different messages that it can handle, the services that it provides or the procedures that it carries out in response to these messages, and the events resulting from the services provided or the procedures carried out, are always very precisely itemized in the manufacturers' specifications.

Advantageously, an object-oriented interface comprises an object aspect provided with subscription-based communication services.

Advantageously, the object-oriented interfaces intercommunicate in accordance with the CORBA standard devised by the “Object Management Group”.

Advantageously, the object-oriented interfaces intercommunicate in accordance with the Java Remote Method Invocation protocol devised by Sun Microsystems, Java being a registered trademark of the latter company.

Advantageously, the object-oriented interfaces intercommunicate in accordance with the Simple Object Access Protocol devised by the “World Wide Web Consortium”.

Advantageously, the object-oriented interfaces intercommunicate via an object in the object-oriented programming sense, called an adapter object, provided with means of adapting the format of the messages and events generated by the object-oriented interfaces so that they can be understood by the recipient object-oriented interface.

Advantageously, when the object-oriented interfaces intercommunicate via an adapter object, the networking system includes a configuration object recognizing all the objects of the network and all the services, and handling the creation of the adapter objects.

Advantageously, when a dedicated aeronautical bus interconnects the onboard equipment, it is used to connect object-oriented interfaces to their assigned equipment.

Advantageously, when a dedicated aeronautical bus interconnects the onboard equipment, it is used to connect object-oriented interfaces to their assigned equipment and to interlink the object-oriented interfaces.

Other advantages and features of the invention will become apparent from the description below of an embodiment given by way of example. This description should be read in light of the drawings in which:

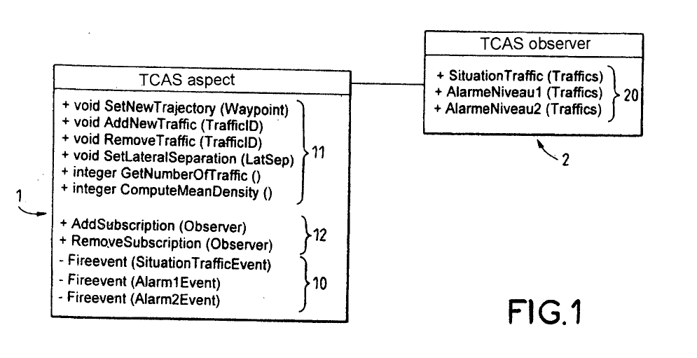

FIG. 1 is a diagram illustrating an object-oriented interface according to the invention for an air traffic collision avoidance system,

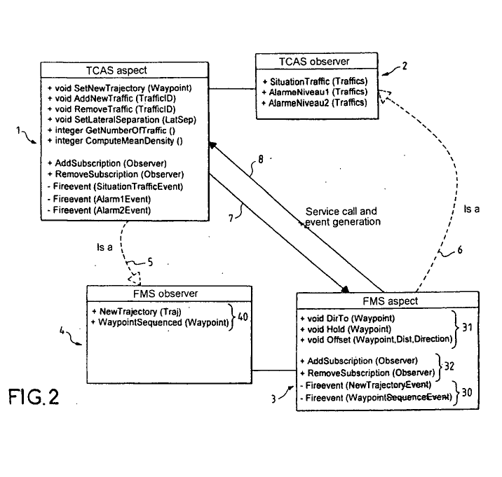

FIG. 2 is a diagram illustrating a direct communication mode between the object-oriented interfaces of a flight computer and an air traffic collision avoidance system placed on board an aircraft,

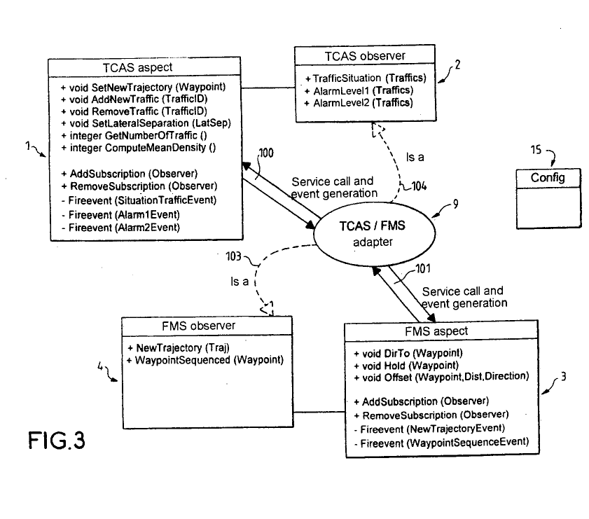

FIG. 3 is a diagram illustrating an indirect communication mode, via an adapter object, between the object-oriented interfaces of a flight computer and an air traffic collision avoidance system placed on board an aircraft,

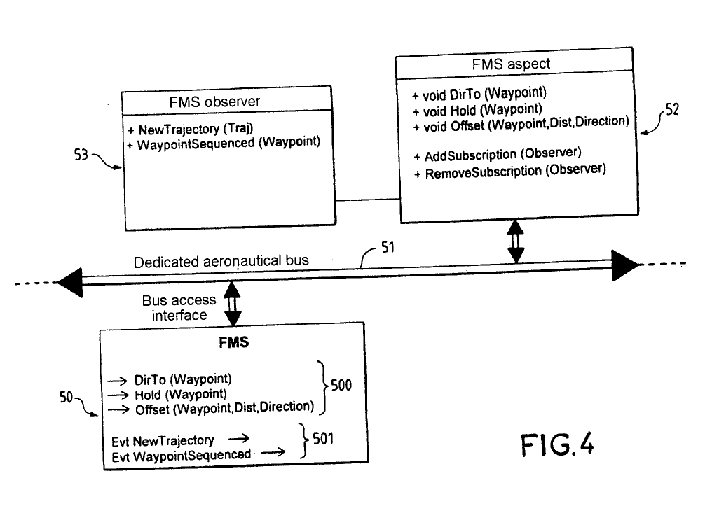

FIG. 4 is a diagram illustrating the connection of an object-oriented interface to a flight computer in the case where the latter is accessible via a dedicated aeronautical bus, and

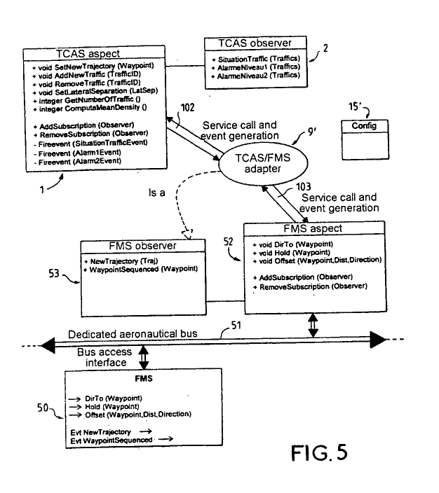

FIG. 5 is a diagram illustrating an indirect communication mode, via an adapter object, between the object-oriented interface of an air traffic collision avoidance system and the object-oriented interface of a flight computer added to the latter via the dedicated aeronautical bus.

Object-oriented programming, OOP, seeks to control the growing complexity of computer programs by organizing a computer program as cooperating sets of independent information processing entities called objects, comprising both data and a collection of structures and linked procedures. It is covered by a large body of literature to which the reader can refer for a detailed knowledge of the subject, in particular the book by Grady BOOCH entitled “Object Oriented Design with Application”, published by Addison-Wesley Pub. Co. (February 1994), ISBN: 0805353402. For the description that follows, it is enough to know that an object in the object-oriented programming sense, models the behaviour of a real world entity learned from a current state of the entity, from the services or procedures that the entity can carry out, from the format of the messages and of the parameters for requesting these services or procedures, and from the events resulting from the services or procedures carried out. The effective structure of the modelled entity, in other words the way in which it carries out the services or procedures is not taken into account in the object that it models, which makes the object-oriented programming model particularly interesting when it comes to equipment for which there is a need to modify the use without in any way affecting their structures or the services that they provide.

The objects cooperate according to a client/server model, an object being considered as the server when it carries out a service at the request of another object, and as the client when it requests a service on the part of another object.

In the case of an aircraft avionics system, each item of equipment such as the automatic pilot, the flight computer, the call router, etc., can have its behaviour modelled by an object in the object-oriented programming sense, using an object-oriented interface with an object aspect including a record of the current state of the equipment and formally describing the services provided with their call parameters, and with observer means collecting the events resulting from the execution of the requested services.

More specifically, the observer means can be behavioural objects in the sense of the “observer” section of the book entitled “Design Patterns” written by Erich Gamma et al. and published as part of the “Addison-Wesley. Professional Computing Series”, ISBN: 0-201-63361-2.

For equipment modelled by objects in the object-oriented programming sense to intercommunicate according to an object-oriented client/server model, it is sufficient to add to their object aspects services or procedures that are specific to them, specializing in communication between objects and accessible from other objects by subscription, and to furnish the modelled equipment that is to use the services provided by other modelled equipment with knowledge bases of services provided by other objects.

FIG. 1 illustrates an example of an object-oriented interface adapted to suit an air traffic collision avoidance system, TCAS. This object-oriented interface comprises an object aspect 1 and observer means 2. In the object aspect 1, the current state of the TCAS is identified by parameter values 10 labelled by their names preceded by a minus sign as a prefix whereas the services provided by the TCAS and their call parameters 11 and the subscription-based communication services 12 provided by the object-oriented interface itself, are labelled by their names preceded by a plus sign as a prefix. In the observer means 2, the events deriving from the services provided by the TCAS are identified by parameter values 20 labelled by their names preceded by a plus sign as a prefix.

The object aspect 1 is a new access to the services provided by the TCAS, whereas the observer means 2 form a database of events to be notified to the client objects that have taken out a subscription.

FIG. 2 illustrates an example of coupling of a TCAS with a flight computer known by the abbreviation FMS (for flight management system) to implement a traffic conflict detection and collision avoidance function. In this example, the TCAS and the FMS computer are considered as objects in the object-oriented programming sense, one being provided with a knowledge base of the services provided that it may have to request of the other and conversely to implement the air traffic conflict detection and collision avoidance function.

The FMS computer is provided, like the TCAS, with an object-oriented interface that models it as an object in the object-oriented programming sense.

In the interests of simplicity, only the object-oriented interfaces are represented in FIG. 2. The object-oriented interface of the TCAS with its object aspect 1 and its observer means 2 is taken from FIG. 1. The object-oriented interface of the FMS computer also has an object aspect 3 and observer means 4, but these are adapted to the behaviour of the FMS computer. The object aspect of the object-oriented interface of the FMS computer identifies the current state of the FMS computer from parameter values 30 labelled by their names preceded by a minus sign as a prefix and the services provided by the FMS computer and their call parameters 31, as well as subscription-based communication services 32 provided by the object-oriented interface (3, 4) itself, from their names preceded by a plus sign as a prefix. The observer means 4 identify the events resulting from the services provided by the FMS computer from parameter values 40 labelled by the names preceded by a plus sign as a prefix.

The object-oriented interfaces 1, 2 of the TCAS and 3, 4 of the flight computer are directly coupled in the sense that each of them is the client of the other and directly takes out subscriptions with the other when needed. They are linked in both directions, logically by “is a” links 5, 6 and physically by a transmission link 7, 8.

This direct coupling mode between the object-oriented interface 1, 2 of the TCAS and the object-oriented interface 3, 4 of the FMS computer requires the object-oriented interface 1, 2 of the TCAS not only to model the TCAS as an object in the object-oriented programming sense, but also to send, to the object-oriented interface 3, 4 of the FMS computer, service request messages according to the format or protocol used by the latter, and to be able to interpret the format in which the object-oriented interface 3, 4 of the FMS computer sends it the events resulting from execution of the requested services. It also requires the object-oriented interface 3, 4 of the FMS computer not only to model the FMS computer as an object in the object-oriented programming sense, but also to send, to the object-oriented interface 1, 2 of the TCAS, service request messages according to the format or protocol used by the latter and to be able to interpret the format in which the object-oriented interface 1, 2 of the TCAS sends it the events resulting from execution of the requested services.

The direct coupling requires an object-oriented interface to be designed not only according to the equipment to be modelled as an object in the object-oriented programming sense, but also according to the object-oriented interfaces of the equipment with which it may have to be connected. This constraint means having to rethink the object-oriented interfaces of the equipment of an avionics system each time a new equipment item is added or each time a change is made to the protocol of the messages accepted by an object-oriented interface or of the events that it sends. Such a rethink is not desirable because it means having to repeat the certification procedures for all of the modified object-oriented interfaces.

To avoid having to take into account, when designing an object-oriented interface, the characteristics of the other object-oriented interfaces with which it may have to communicate, another example of coupling of a TCAS with an FMS computer is proposed, in relation to FIG. 3, to perform a traffic conflict detection and collision avoidance function, both the TCAS and the FMS computer still being considered as objects in the object-oriented programming sense. In this other form of coupling, the object-oriented interfaces 1, 2 and 3, 4 of the TCAS and of the FMS computer are no longer connected directly but via another object 9, still in the object-oriented programming sense, called an adapter object, providing the adaptations necessitated by any differences of message and event protocols.

FIG. 3 again shows the object-oriented interface 1, 2 of the TCAS and the object-oriented interface 3, 4 of the FMS computer. These are unaware of each other while being aware of a set of accessible services. On each expression of a service requirement from the other equipment, a specific adapter object 9 is created to connect them and handle the necessary protocol conversions.

The adapter object 9 is linked, in both directions, by transmission links 100, 101, to the object interface 1, 2 of the TCAS and to the object interface 3, 4 of the FMS computer. It subscribes as a client to both of these object interfaces 1, 2 and 3, 4 via “is a” links 103, 104.

Another configuration object 15, which knows all the objects and all the services, handles the creation of the adapter objects 9 according to the interconnection requirements.

No application know-how (other than protocol-related) is incorporated in the adapter objects 9.

Experience shows that the computation times associated with these formattings are low relative to the processing times taken by the services provided. The cost of developing these adapter objects is, in principle, low since it involves only data formatting.

The major interest of the adapter objects 9 is the weak coupling between object models that they enable. This weak coupling can be used to confine most of the consequences of the insertion of new equipment in an avionics system to the creation of new adapter objects, with the pre-existing equipment being subjected, where necessary, to an update of their knowledge base of the services provided to include therein the services provided by the new equipment and the events that it is likely to generate.

The object-oriented interfaces 1, 2; 3, 4 and the adapter objects 9 advantageously comply with a distributed multi-vendor applications standard or protocol such as the CORBA standard devised by the “Object Management Group” or the Java Remote Method Invocation protocol devised by Sun Microsystems, Java being a registered trademark of the latter company, or even the Simple Object Access Protocol devised by the “World Wide Web Consortium”.

An object-oriented interface of an equipment item, which provides for the transition between the non-object-oriented world of an item equipment and the object-oriented world of the networking system is a software machine which can be produced by combinational or sequential logic, either using custom integrated circuits mounted on an electronic daughter board placed inside the housing of the modelled equipment and connected to the proprietary buses of the latter, or by using the computation time of a computer belonging to the modelled equipment. In both cases, the addition of an object-oriented interface compromises the integrity of equipment which must undergo new tests to retain its certification. These two methods are suited only to new equipment designed from the outset with an object-oriented interface. For equipment already present in the avionics system, they still raise the problem of recertification even though this problem is alleviated by the fact that the structure of the equipment is not affected.

FIG. 4 shows another way of adding an object-oriented interface to equipment on board an aircraft, when the latter is connected to a data transmission dedicated aeronautical bus as is the case, for example, with the commercial aircraft model Boeing 777 built by Boeing, or the future commercial aircraft model A 380 currently being built by Airbus.

The equipment involved is an FMS computer represented by its interface 50 for accessing a dedicated aeronautical bus 51. Its object-oriented interface with its object aspect 52 and its observer means 53 is connected to it via a dedicated aeronautical bus 51 and its bus access interface 50.

The connection to the FMS computer, of its object-oriented interface 52, 53 via the dedicated aeronautical bus 51 and of its interface 50 for access to this dedicated aeronautical bus 51, is made possible by the fact that the access interface 50 is a software machine designed to enable the avionics system to access all the services that the FMS computer can provide (parameters preceded by incoming arrows identified by the number 500) and all the events liable to be generated by the FMS computer and its state (parameters followed by outgoing arrows identified by the number 501).

This connection mode makes it possible to achieve total respect for the integrity of the FMS computer and therefore its certification, if it is accepted that the FMS computer should not be allowed to benefit from the services of the added TCAS. In this case, the FMS computer is seen by the TCAS only as a possible server, but never as a client.

FIG. 5 illustrates an example of coupling, of the type of that in FIG. 3, between a TCAS newly added to an avionics system and a pre-existing FMS computer, accessible in the avionics system via a dedicated aeronautical bus, designed to perform an air traffic conflict detection and collision avoidance function, without affecting the integrity of the FMS computer to retain its certification.

As in the preceding figure, the FMS computer is provided with an object-oriented interface, with an object aspect 52 and observer means 53, which is connected to it via the dedicated aeronautical bus 51 and its bus access interface 50. The TCAS, which is newly added to the avionics system, incorporates an object-oriented interface with an object aspect 1 and observer means 2. The TCAS and the FMS computer intercommunicate via their object-oriented interfaces 1, 2 and 52, 53 interlinked via an adapter object 9′ and transmission links 102, 103 created each time the need for it is detected by a configuration object 15′.

In the case considered here of total respect for the integrity of the pre-existing FMS computer of the avionics system, an adapter object 9′ connecting the TCAS and the FMS computer is a subscriber only to the FMS computer since the latter was not designed from the outset to benefit from the services provided by the TCAS and there is no desire to affect its integrity. This will not prevent a subsequent upgrade of the FMS computer, at the cost of recertification and the use of adapter objects subscribing both to the FMS computer and to the TCAS.

The transmission links 102, 103 between object-oriented interfaces 1, 2; 52, 53 and the adapter object 9′ can use the dedicated aeronautical bus, the data interchanged between them using a protocol superlayer advantageously of the distributed multi-vendor applications protocol type such as the CORBA standard devised by the “Object Management Group” or the Java Remote Method Invocation protocol devised by Sun Microsystems, Java being a registered trademark of the latter company, or even the Simple Object Access Protocol devised by the “World Wide Web Consortium”.

1. A system for networking aeronautical equipment on board an aircraft comprising, for each equipment item, an object-oriented interface with object aspect means, enabling it to recognize the onboard equipment to which it is assigned, capable of communicating with other objects according to an object-oriented client/server model and with observer means recording the events resulting from operation of the equipment.

2. The system according to claim 1, wherein, said object-oriented interface comprises an object aspect provided with subscription-based communication services.

3. The system according to claim 1, wherein, said object-oriented interfaces comply with a multi-vendor distributed applications protocol.

4. The system according to claim 1, wherein, said object-oriented interfaces comply with the CORBA standard devised by the Object Management Group.

5. The system according to claim 1, wherein said object-oriented interfaces comply with the Java Remote Method Invocation protocol.

6. The system according to claim 1, wherein said object-oriented interfaces comply with the Simple Object Access Protocol devised by the World Wide Web Consortium.

7. The system according to claim 1, wherein said object-oriented interfaces intercommunicate via an object called an adapter object provided with means of adapting the format of the messages and events generated by the object-oriented interfaces so that they can be understood by the recipient object-oriented interface.

8. The system according to claim 7, wherein it includes a configuration object recognizing all the objects, of the network and all the services, and handling the creation of the adapter objects.

9. The system according to claim 7, wherein an adapter object complies with the CORBA standard devised by the Object Management Group.

10. The system according to claim 7, wherein an adapter object complies with the Java Remote Method Invocation protocol.

11. The system according to claim 7, wherein an adapter object complies with the Simple Object Access Protocol devised by the World Wide Web Consortium.

12. The system according to claim 1, used in an avionics system comprising a dedicated aeronautical bus, wherein said object-oriented interfaces are connected to their assigned equipment items via the dedicated aeronautical bus.

13. The system according to claim 1, used in an avionics system comprising a dedicated aeronautical bus, wherein object-oriented interfaces intercommunicate via the dedicated aeronautical bus.

14. The system according to claim 1, wherein one of the aeronautical equipment items is an air traffic collision avoidance system TCAS and another aeronautical equipment item is a flight computer FMS.
